(19) United States
(12) Patent Application Publication
(10) Pub. No.: US 2003/0144413 A1
(43) Pub. Date: Jul. 31, 2003

(54) Pseudoplastic powdered lacquer slurry free of organic solvent and external emulsifiers, method for production and use thereof

(76) Inventors: Gunther Ott, Munster (DE); Joachim Woltering, Munster (DE); Ulrike Rockrath, Senden (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/343,472

(22) PCT Filed: Aug. 17, 2001
(86) PCT No.: PCT/EP01/09487

(30) Foreign Application Priority Data
Aug. 17, 2000 (DE) 100 40 223.2

(51) Int. Cl. C08K 3/00

(52) U.S. Cl. 524/589

(57) ABSTRACT

The invention relates to a pseudoplastic powdered lacquer slurry, free of organic solvents and external emulsifiers comprising solid and/or highly viscous particles which are dimensionally stable under storage and application conditions with an average particle size of 0.8 to 20 μm and a maximum particle size of 30 μm, whereby said particles contain at least one binding agent and at least one cross-linking agent. As cross-linking agent: (A) at least one cross-linking agent, by means of which soft segments may be introduced into the three-dimensional network of the lacquer, (B) at least one cross-linking agent, by means of which hard segments may be introduced into the three-dimensional network of the lacquer or alternatively (A/B) at least one cross-linking agent, by means of which both soft and hard segments may be introduced into the three-dimensional network is/are used.

The present invention relates to a novel powder clearcoat slurry free from organic solvents and external emulsifiers which possesses pseudoplasticity. Moreover, the present invention relates to a novel process for preparing said powder clearcoat slurry. The invention relates not least to the use of the novel powder clearcoat slurry to produce clearcoats for automotive OEM finishing and refinishing, industrial coating, including coil coating, container coating, and the coating or impregnation of electrical components, and the coating of furniture, windows, doors, and interior and exterior architecture.

International Patent Application WO 00/15721 discloses a powder clearcoat slurry free from organic solvents and external emulsifiers and comprising solid spherical particles having an average size of from 0.8 to 20 μm and a maximum size of 30 μm, said slurry containing from 0.05 to 1 meq/g of ion-forming groups, from 0.05 to 1 meq/g of neutralizing agents, and having a viscosity of (i) from 50 to 1000 mPas at a shear rate of 1000 s⁻¹, (ii) from 150 to 8000 mPas at a shear rate of 10 s⁻¹, and (iii) from 180 to 12,000 mPas at a shear rate of 1 s⁻¹. This known powder clearcoat slurry comprises as crosslinking agent a blocked polyisocyanate based on isophorone diisocyanate, which has been reacted with trimethylolpropane in a molar ratio of 3:1 to give a trimer containing urethane groups, after which the remaining free isocyanate groups have been blocked with 3,5-dimethylpyrazole.

On page 11, lines 23 to 25, international Patent Application WO 00/15721 refers to the possibility of using, inter alia, the blocked polyisocyanates described in patent applications DE 196 17 086 A1, DE 196 31 269 A1, or EP 0 004 571 A1. Proposed in particular therein are blocked polyisocyanates based on hexamethylene diisocyanate, butane diisocyanate, isophorone diisocyanate, hydrogenated and unhydrogenated tolylidene diisocyanate, xylylidene diisocyanate, 4,4′-diiso-cyanatodicyclohexylmethane, 4,4′-diphenylmethane diisocyanate, and 3(4)-isocyanatomethyl-1-methyl-cyclohexyl isocyanate. No relationship is can be established, however, between the structure of the polyisocyanates and the blushing tendency of clearcoats based on the known powder clearcoat slurry.

The known powder clearcoat slurry is preparable with a comparatively small number of processing steps. It possesses advantageous application properties on the basis of its typical powder slurry properties, with residual solvent contents of <1%, and its low particle sizes. Following application, it dries in powder form during the evaporation phase at room temperature or slightly elevated temperature. Baking gives popping-free clearcoats of high gloss with dry film thicknesses of approximately 40-60 μm.

On exposure to moisture, however, as for example under constant humidity conditions or in the hot water test, the clearcoats have a tendency to whiten (blush), which adversely affects their broad application in particular in the automotive sector.

A comparable powder clearcoat slurry is described in German Patent Application DE 100 01 442.9, unpublished at the priority date of the present specification.

It is an object of the present invention to provide a new powder clearcoat slurry which continues to have all of the advantages of the prior art powder clearcoat slurry but which no longer blushes after exposure to moisture.

Accordingly we have found the novel, pseudoplastic powder clearcoat slurry free from organic solvents and external emulsifiers and comprising solid and/or highly viscous particles, dimensionally stable under storage and application conditions, having an average size of from 0.8 to 20 μm and a maximum size of 30 μm, said particles comprising at least one binder and at least one crosslinking agent, said crosslinking agent comprising

(A) at least one crosslinking agent which introduces soft segments into the three-dimensional network of the clearcoat, and

(B) at least one crosslinking agent which introduces hard segments into the three-dimensional network of the clearcoat,

or alternatively

(A/B) at least one crosslinking agent which introduces both soft and hard segments into the three-dimensional network of the clearcoat.

In the text below, the novel, pseudoplastic powder clearcoat slurry free from organic solvents and external emulsifiers is referred to for short as “slurry of the invention”.

In the light of the prior art, it was surprising and unforeseeable by the skilled worker that the problem on which the present invention is based might be achieved using crosslinking agents which introduce hard and soft segments into the three-dimensional networks of the clearcoats produced from the slurry of the invention. On the contrary, the prior art gave the expectation that the use of such crosslinking agents would have no effect on the tendency toward blushing, since no such connection could be inferred from the prior art.

The constituents of the slurry of the invention that are essential to the invention are the crosslinking agents (A), which introduce soft segments into the three-dimensional network of the clearcoat, and the crosslinking agents (B), which introduce hard segments into the three-dimensional network of the clearcoat. Instead of or in addition to these crosslinking agents (A) and (B) it is also possible to use crosslinking agents (A/B) which introduce both soft and hard segments into the three-dimensional network of the clearcoat.

Since the crosslinking agents (A) and (B) are easier to prepare than the crosslinking agents (A/B) and easier to adapt, via both the structure and the proportions, to the requirements of each individual case, they are preferred.

In the context of the present invention, soft segments are molecular building blocks which lower the glass transition temperature Tg of three-dimensional networks in which they are included. Hard segments, on the other hand, are molecular building blocks which raise the glass transition temperature Tg of three-dimensional networks in which they are included.

Examples of suitable hard and soft segments are divalent organic radicals.

Examples of suitable soft divalent organic radicals are substituted or unsubstituted, preferably unsubstituted, linear or branched, preferably linear, alkanediyl radicals having 4 to 20, preferably 5 to 10, and in particular 6 carbon atoms.

Examples of highly suitable linear alkanediyl radicals are tetramethylene, pentamethylene, hexamethylene, heptamethylene, octamethylene, nonane-1,9-diyl, decane-1,10-diyl, undecane-1,11-diyl dodecane-1,12-diyl, tridecane-1,13-diyl, tetradecane-1,14-diyl, pentadecane-1,15-diyl, hexadecane-1,16-diyl, heptadecane-1,17-diyl, octadecane-1,18-diyl, nona-decane-1,19-diyl or eicosane-1,20-diyl, preferably tetramethylene, pentamethylene, hexamethylene, heptamethylene, octamethylene, nonane-1,9-diyl and decane-1,10-diyl, especially hexamethylene.

Suitable substituents are all organic functional groups that are essentially inert, i.e., which do not enter into any reactions with the crosslinking agents (A), (B) and (A/B) or other constituents of the slurry of the invention.

Examples of suitable inert organic radicals are halogen atoms, nitro groups, nitrile groups, or alkoxy groups.

The hard divalent organic radicals are aromatic or cycloaliphatic radicals. With a view to the weathering stability of the clearcoat of the invention, it is preferred to use cycloaliphatic radicals of these, in turn, substituted or unsubstituted, preferably unsubstituted, cycloalkanediyl radicals having 4 to 20 carbon atoms are advantageous and are therefore used with preference in accordance with the invention.

Examples of highly suitable cycloalkanediyl radicals having 4 to 20 carbon atoms are cyclobutane-1,3-diyl, cyclopentane-1,3-diyl, cyclohexane-1,3- or -1,4-diyl, cycloheptane-1,4-diyl, norbornane-1,4-diyl, adamantane-1,5-diyl, decalindiyl, 3,3,5-trimethylcyclohexane-1,5-diyl, 1-methylcyclohexane-2,6-diyl, dicyclohexylmethane-4,4′-diyl, 1,1′-dicyclohexane-4,4′-diyl or 1,4-dicyclohexylhexane-4,4″-diyl, especially 3,3,5-trimethylcyclohexane-1,5-diyl or dicyclohexylmethane-4,4′-diyl.

Examples of suitable substituents are those described above.

Suitable crosslinking agents (A) in accordance with the invention are all those which introduce at least one, preferably at least two, and in particular at least three of the above-described soft segments into the clearcoats.

Suitable crosslinking agents (B) in accordance with the invention are all those which introduce at least one, preferably at least two, and in particular at least three of the above-described hard segments into the clearcoats.

Moreover, suitable crosslinking agents (A/B) are all those which introduce at least one, preferably at least two, of the above-described soft segments and at least one, preferably one, of the above-described hard segments, or at least one, preferably one, of the above-described soft segments and at least one, preferably at least two, of the above-described hard segments.

Because of their structural diversity and their ready availability, blocked polyisocyanates containing the segments described above offer particular advantages and are therefore used with very particular preference in accordance with the invention as crosslinking agents (A) and (B) and/or (A/B).

Suitable blocked polyisocyanates (A) and (B) or (A/B) possess, in terms of the blocked isocyanate groups, a functionality of >2, preferably from 2.1 to 10, more preferably from 2.5 to 8, with particular preference from 2.8 to 6, with very particular preference from 3 to 5, and in particular from 3 to 4.

Preferably, the blocked polyisocyanates (A) and (B) or (A/B) are prepared from diisocyanates containing the corresponding segments.

Examples of suitable polyisocyanates used to prepare the blocked polyisocyanates (A) or (A/B) are tetramethylene diisocyanate, pentamethylene diisocyanate or hexamethylene diisocyanate, especially hexamethylene diisocyanate.

Examples of suitable polyisocyanates used to prepare the blocked polyisocyanates (B) or (A/B) are isophorone diisocyanate or 4,4′-diisocyanatodicyclo-hexylmethane, especially isophorone diisocyanate.

The diisocyanates are converted into polyisocyanates using customary and known reactions. The resultant polyisocyanates are oligomers which contain isocyanurate, biuret, allophanate, iminooxadiazinedione, urethane, carbodiimide, urea and/or uretdione groups. Examples of suitable preparation processes are known, for example, from patents and patent applications CA 2,163,591 A1, U.S. Pat. No. 4,419,513 A, U.S. Pat. No. 4,454,317 A, EP 0 646 608 A1, U.S. Pat. No. 4,801,675 A1, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A, U.S. Pat. No. 5,290,902 A, EP 0 649 806 A1, DE 42 29 183 A1 or EP 0 531 820 A1.

Very particular preference is given to the use of the oligomers of hexamethylene diisocyanate and of isophorone diisocyanate.

The polyisocyanates are blocked, furthermore, with suitable blocking agents. Examples of suitable blocking agents are

i) phenols such as phenol, cresol, xylenol, nitrophenol, chlorophenol, ethylphenol, t-butyl-phenol, hydroxybenzoic acid, esters of this acid, or 2,5-di-tert-butyl-4-hydroxytoluene;

ii) lactams, such as ε-caprolactam, δ-valerolactam, γ-butyrolactam of β-propiolactam;

iii) active methylenic compounds, such as diethyl malonate, dimethyl malonate, methyl or ethyl acetoacetate or acetylacetone;

iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, diethylene glycol monomethyl ether, diethylene glycol monoethyl ether, propylene glycol monomethyl ether, methoxymethanol, trimethylolpropane, glycerol, glycolic acid, glycolic esters, lactic acid, lactic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;

v) mercaptans such as butyl mercaptan, hexyl mercaptan, t-butyl mercaptan, t-dodecyl mercaptan, 2-mercaptobenzothiazole, thiophenol, methylthiophenol or ethylthiophenol;

vi) acid amides such as acetoanilide, acetoanisidinamide, acrylamide, methacrylamide, acetamide, stearamide or benzamide;

vii) imides such as succinimide, phthaiimide or maleimide;

viii) amines such as diphenylamine, phenyl-naphthylamine, xylidine, N-phenylxylidine, carbazole, aniline, naphthylamine, butylamine, dibutylamine or butylphenylamine;

ix) imidazoles such as imidazole or 2-ethyl-imidazole;

x) ureas such as urea, thiourea, ethyleneurea, ethylenethiourea or 1,3-diphenylurea;

xi) carbamates such as phenyl N-phenylcarbamate or 2-oxazolidone;

xii) imines such as ethyleneimine;

xiii) oximes such as acetone oxime, formaldoxime, acetaldoxime, acetoxime, methyl ethyl ketoxime, diisobutyl ketoxime, diacetyl monoxime, benzophenone oxime or chlorohexanone oximes;

xiv) salts of sulfurous acid such as sodium bisulfite or potassium bisulfite;

xv) hydroxamic esters such as benzyl methacrylohydroxamate (BMH) or allyl methacrylohydroxamate; or

xvi) substituted pyrazoles or triazoles; and

xvii) mixtures of these blocking agents.

Particular preference is given to the use of substituted pyrazoles (xvi) such as 3,4-dimethyl- and/or 3,5-dimethylpyrazole or mixtures (xvii) of 3,4-dimethyl- and/or 3,5-dimethylpyrazole and trimethylolpropane.

An example of a very particularly highly suitable blocked polyisocyanate (A) is the trimer or cyanurate of hexamethylene diisocyanate blocked with 3,5-dimethylpyrazole.

An example of a very particularly highly suitable blocked polyisocyanate (B) is the reaction product of isophorone diisocyanate and trimethylolpropane in a molar ratio of 3:1 whose free-isocyanate groups are blocked with 3,5-dimethylpyrazole.

The amount of the above-described crosslinking agents in the particles of the slurry of the invention may vary very widely and is guided primarily by the number of complementary reactive functional groups in the binders and the functionality of the crosslinking agents. Based on its solids content, the slurry of the invention preferably contains from 5 to 60, more preferably from 15 to 55, with particular preference from 20 to 50, with very particular preference from 25 to 50, and in particular from 30 to 45% by weight of the crosslinking agents.

The proportion of crosslinking agents (A) to crosslinking agents (B) may also vary widely. Preferably, the ratio of equivalents in the case of (A):(B) is from 10:1 to 1:10, more preferably from 9:1 to 1:5, with particular preference from 8:1 to 1:4, with very particular preference from 6:1 to 1:2, and in particular from 4:1 to 1:1.

In addition to the above-described crosslinking agents (A) and (B) and/or (A/B) for use in accordance with the invention, the slurry of the invention may further comprise minor amounts of at least one further, customary and known crosslinking agent, i.e., the crosslinking characteristics of the slurry of the invention are determined primarily by the above-described crosslinking agents for use in accordance with the invention. The amount of additional crosslinking agents is preferably up to 10% by weight, based on the overall amount of the crosslinking agents. Examples of suitable additional crosslinking agents are tris(alkoxycarbonylamino)triazines, as described in U.S. Pat. Nos. 4,939,213 A, US 5,084,541 A or US 5,288,865 A, or in European Patent Application EP 0 604 922 A1.

For the slurry of the invention it is essential, moreover, that the average size of the solid particles is from 0.8 to 20 μm and, with particular preference, from 3 to 15 μm. By the average particle size is meant the 50% median value as determined by the laser diffraction method, i.e., 50% of the particles have a diameter≦the median value and 50% of the particles have a diameter≧the median value.

Slurries having average particle sizes of this kind and a solvent content of <1% exhibit better application properties and, at the applied film thicknesses of >30 μm as presently practiced in the automotive industry for the finishing of automobiles, exhibit little tendency, if any, toward popping and mudcracking.

The upper limit for particle size is reached when the size of the particles means that they are no longer able to flow out fully on baking, and thus the film leveling is adversely affected. In cases where requirements regarding the appearance are not very stringent, however, they may also be higher. 30 μm is considered a sensible upper limit, since above this particle size the spray nozzles and conveying units of the highly sensitive apparatus may become blocked.

The particles present in the slurry of the invention are solid and/or highly viscous. In the context of the present invention, “highly viscous” means that under the customary and known conditions of the storage and application of powder clearcoat slurries the particles behave essentially as solid particles.

Furthermore, the particles present in the slurry of the invention are dimensionally stable. In the context of the present invention “dimensionally stable” means that under the customary and known conditions of the storage and application of powder clearcoat slurries the particles neither agglomerate nor break down into smaller particles but instead essentially retain their original form even under the influence of shear forces.

The slurry of the invention is free from organic solvents. In the context of the present invention this means that it has a residual volatile solvent content of <1% by weight, preferably <0.5% by weight, and with particular preference <0.2% by weight. In accordance with the invention it is of very particular advantage if the residual content is below the gas chromatography detection limit.

In the context of the present invention, the expression “free from external emulsifiers” is to be understood in the same way.

The above-described particle sizes for use in accordance with the invention are obtained even without the aid of additional external emulsifiers if the binder comprises ion-forming groups in accordance with an average acid number or amine number of from 3 to 56 g KOH/g solids (MEQ acid or amine of from 0.05 to 1.0 meq/g solids), preferably up to 28 (MEQ acid or amine: 0.5), and in particular up to 17 (MEQ acid or amine: 0.3).

It is preferred to aim for a low level of such groups, since when the customary crosslinking agents are used, such as blocked polyisocyanates, for example, free groups of this kind remain in the film and may reduce the resistance to ambient substances and chemicals. On the other hand, the acid group content must still be sufficiently high to ensure the desired stabilization.

The ion-forming groups are neutralized using neutralizing agents to the extent of 100% or else only partly neutralized, to the extent of <100%. The amount of neutralizing agent is chosen so that the MEQ value of the slurry of the invention is below 1, preferably below 0.5, and in particular below 0.3 meq/g solids. In accordance with the invention it is of advantage if the amount of neutralizing agent corresponds at least to an MEQ value of 0.05 meq/g solids.

In general, therefore, the chemical nature of the binder is not restrictive provided it comprises ion-forming groups which are convertible by neutralization into salt groups and so are able to take on the function of ionically stabilizing the particles in water.

Suitable anion-forming groups are acid groups such as carboxylic, sulfonic or phosphonic groups. Accordingly, the neutralizing agents used are bases, such as alkali metal hydroxides, ammonia, or amines. Alkali metal hydroxides are suitable for use only to a limited extent, since the alkali metal ions are nonvolatile on baking and, owing to their incompatibility with organic substances, may cloud the film and result in losses of gloss. Consequently, ammonia or amines are preferred. In the case of amines, preference is given to water-soluble tertiary amines. By way of example, mention may be made of N,N-dimethylethanolamine or aminomethylpropanolamine (AMP).

Suitable cation-forming groups are primary, secondary or tertiary amines. Accordingly, neutralizing agents used are, in particular, low molecular mass organic acids such as formic acid, acetic acid, or lactic acid.

Binders which contain cation-forming groups are known from the field of electrodeposition coating materials. By way of example, reference may be made to patent application EP 0 012 463 A1 or EP 0 612 818 A1 or to patent U.S. Pat. No. 4,071,428 A.

For the preferred use of the slurry of the invention as unpigmented clearcoats in automotive finishing, preference is given to polymers or oligomers containing acid groups as ion-forming groups, since these so-called anionic binders are generally more resistant to yellowing than the class of the cationic binders.

Nevertheless, cationic binders with groups convertible into cations, such as amino groups, are likewise suitable for use in principle provided the field of use is tolerant of their typical secondary properties, such as their tendency toward yellowing.

As binders which contain anion-forming groups, it is possible to use any desired resins containing the abovementioned acid groups. However, it is essential that they also carry further groups which ensure crosslinkability. In accordance with the invention, hydroxyl groups are preferred.

Suitable oligomers and polymers of this kind for use in accordance with the invention are hydroxyl-containing, preferably linear and/or branched and/or block, comb and/or random poly(meth)acrylates, polyesters, alkyds, polyurethanes, acrylated polyurethanes, acrylated polyesters, polylactones, polycarbonates, polyethers, (meth)acrylatediols, or polyureas.

In addition to the hydroxyl groups, the oligomers and polymers may also contain other functional groups such as acryloyl, ether, amide, imide, thio, carbonate, or epoxy groups, provided they do not disrupt the crosslinking reactions.

These oligomers and polymers are known to the skilled worker, and many suitable compounds are available on the market.

In accordance with the invention, the polyacrylates, the polyesters, the alkyd resins, the polyurethanes and/or the acrylated polyurethanes are of advantage and are therefore used with preference.

Examples of suitable polyacrylates are described in European Patent Application EP-A-0 767 185 and U.S. Pat. Nos. 5,480,493 A, US 5,475,073 A, and US 5,534,598 A. Further examples of particularly preferred polyacrylates are marketed under the brand name Joncryl^{R}, such as Joncryl^{R} SCX 912 and 922.5, for instance. The preparation of these polyacrylates is common knowledge and is described, for example, in the standard work Houben-Weyl, Methoden der organischen Chemie, 4th Edition, volume 14/1, pages 24 to 255, 1961.

The preparation of the polyesters and alkyd resins whose use is preferred in accordance with the invention is common knowledge and is described, for example, in the standard work Ullmanns Enzyklopadie der technischen Chemie, 3rd Edition, volume 14, Urban & Schwarzenberg, Munich, Berlin, 1963, pages 80 to 89 and pages 99 to 105, and in the following books: “Resines Alkydes-Polyesters” by J. Bourry, Paris, Dunod, 1952, “Alkyd Resins” by C. R. Martens, Reinhold Publishing Corporation, New York, 1961, and “Alkyd Resin Technology” by T. C. Patton, Interscience Publishers, 1962.

The polyurethanes and/or acrylated polyurethanes whose use is particularly preferred in accordance with the invention are described, for example, in patent applications EP 0 708 788 A1, DE 44 01 544 A1, or DE 195 34 361 A1.

The slurry of the invention comprises nonionic and ionic thickeners. This effectively counters the tendency of the comparatively large solid and/or highly viscous particles toward sedimentation.

Examples of nonionic thickeners are hydroxyethylcellulose and polyvinyl alcohols. Nonionic associative thickeners are likewise available on the market in diverse selection. They generally consist of water-dilutable polyurethanes, the reaction products of water-soluble polyetherdiols, aliphatic diisocyanates and monofunctional hydroxy compounds with an organophilic radical.

Likewise commercially available are ionic thickeners. These usually contain anionic groups and are based in particular on special polyacrylate resins containing acid groups, some or all of which may have been neutralized.

Examples of suitable thickeners for use in accordance with the invention are known from the text book “Lackadditive” [Coatings Additives] by Johan Bielemann, Wiley-VCH, Weinheim, New York, 1998, pages 31 to 65.

For the slurry of the invention it is essential that both of the above-described types of thickener are present therein. The amount of thickeners to be added and the ratio of ionic to nonionic thickener is guided by the desired viscosity of the slurry of the invention, which in turn is determined by the required sedimentation stability and by the special requirements of spray application. The skilled worker will therefore be able to determine the amount of the thickeners and the ratio of the thickener types to one another on the basis of simple considerations, possibly with the aid of preliminary tests.

It is preferred to set a viscosity range of from 50 to 1500 mPas at a shear rate of 1000 s⁻¹ and from 150 to 8000 mPas at a shear rate of 10 s⁻¹, and also from 180 to 12,000 mPas at a shear rate of 1 s⁻¹.

This viscosity behavior, known as “pseudoplasticity”, describes a state which does justice both to the requirements of spray application, on the one hand, and to the requirements in terms of storage and sedimentation stability, on the other: in the state of motion, such as when pumping the slurry of the invention in circulation in the ring circuit of the coating installation and when spraying, for example, the slurry of the invention adopts a state of low viscosity which ensures easy processability. Without shear stress, on the other hand, the viscosity rises and thus ensures that the coating material already present on the substrate to be coated has a reduced tendency to form runs on vertical surfaces. In the same way, a result of the higher viscosity in the stationary state, such as during storage, for instance, is that sedimentation of the solid and highly viscous particles is largely prevented or that any slight degree of settling of the powder slurry of the invention during the storage period can be removed again by agitation.

In addition to the essential constituents described above, the particles of the slurry of the invention may comprise additives as commonly used in clearcoats. In this context it is essential that these additives do not substantially lower the glass transition temperature Tg of the binders.

Examples of suitable additives are polymers, crosslinking catalysts, devolatilizers, defoamers, adhesion promoters, additives for improving substrate wetting, additives for improving surface smoothness, flatting agents, light stabilizers, corrosion inhibitors, biocides, flame retardants, and polymerization inhibitors, especially photoinhibitors, as described in the book “Lackadditive” by Johan Bielemann, Wiley-VCH, Weinheim, New York, 1998.

Crosslinking components, reactive diluents or leveling assistants which may be incorporated by crosslinking in the film may be added to the slurry of the invention. It is important, however, that these components are located preferably in the external, aqueous phase of the slurry of the invention and not in the disperse organic phase, where they would bring about a lowering of the glass transition temperature Tg and thus coalescence or coagulation of any sedimented particles.

Examples of suitable compounds of this type are polyols. Examples of suitable polyols are positionally isomeric diethyloctanediols or hydroxyl-containing hyperbranched compounds or dendrimers or hydroxyl-containing metathesis oligomers, as described in patent applications DE 198 09 643 A1, DE 198 40 605 A1, and DE 198 05 421 A1.

It is of advantage in accordance with the invention to prepare the slurry of the invention by means of the process described below.

In the preferred process, the ionically stabilizable binders and the crosslinking agents and also, if appropriate, the additives are mixed in organic solution and dispersed together in water with the aid of neutralizing agents by the secondary dispersion process. The system is then diluted with water, while stirring. A water-in-oil emulsion is formed first of all, which on further dilution changes to become an oil-in-water emulsion. This point is generally reached at solids contents of <50% by weight, based on the emulsion, and is evident externally from a relatively sharp drop in viscosity in the course of dilution.

The emulsion thus obtained, which still contains solvent, is subsequently freed from solvents by means of azeotropic distillation (stripping).

The distillation temperature is guided primarily by the glass transition temperature Tg of the binder. In order to avoid coagulum, i.e., coalescence of the particles, which are only slightly stabilized in accordance with the invention, to form a separate continuous organic phase during the distillation, it is essential that the distillation temperature be held below the glass transition temperature Tg. The glass transition temperature may also be described, as a substitute, by the minimum film-forming temperature of the dispersion. The minimum film-forming temperature may be determined by drawing down the dispersion onto a glass plate using a bar coater and heating it in a gradient oven. The temperature at which the pulverulent layer films is designated the minimum film-forming temperature. For further details, reference is made to Römpp Lexikon Lacke und Druckfarben, Georg Thieme Verlag, Stuttgart, New York, 1998, “Minimum film-forming temperature”, page 391.

It is of advantage if the minimum film-forming temperature of the binders is at least 0° C., preferably at least 10, with particular preference at least 15, with very particular preference at least 20, and in particular at least 25° C.

It is also of advantage if the solvents to be removed are distilled off at a distillation temperature below 70° C., preferably below 50° C. and in particular below 40° C. If appropriate, the distillation pressure is chosen so that in the case of higher-boiling solvents this temperature range is still maintained.

At its simplest, the azeotropic distillation may be realized by stirring the emulsion at room temperature in an open vessel for several days. In the preferred case, the solvent-containing emulsion is freed from the solvents by a vacuum distillation.

In order to avoid high viscosities, the amount of water and solvents removed by distillation or evaporation is replaced by water. The water may be added before, during or after the evaporation or distillation, in portions.

After the solvents have been lost, the glass transition temperature Tg of the dispersed particles rises, and instead of the previous solvent-containing emulsion (liquid-in-liquid dispersion) a solid-in-liquid dispersion, or the slurry of the invention, is formed.

The particles of the slurry of the invention may also be mechanically comminuted in the wet state, which is known as wet milling. In this case it is preferred to employ conditions such that the temperature of the milled material does not exceed 70° C., preferably 60° C., and in particular 50° C. Preferably, the specific energy input during the milling process is from 10 to 1000, preferably from 15 to 750, and in particular from 20 to 500 Wh/g.

For wet milling it is possible to employ a very wide variety of equipment which produces high or low shear fields.

Examples of suitable equipment which produces low shear fields are customary and known stirred vessels, slot homogenizers, microfluidizers, and dissolvers.

Examples of suitable equipment which produces high shear fields are customary and known stirred mills and in-line dissolvers.

Particular preference is given to employing the equipment which produces high shear fields. Of these, the stirred mills are particularly advantageous in accordance with the invention and are therefore used with very particular preference.

During wet milling, generally, the slurry is supplied to the above-described equipment and circulated therein by means of appropriate devices, such as pumps, until the desired particle size has been reached and the slurry of the invention is the result.

On energy grounds, it is particularly advantageous if the slurry to be milled includes only a fraction, preferably from 5 to 90, more preferably from 10 to 80, and in particular from 20 to 70% by weight, of the above-described thickener that is present in the slurry of the invention. Where this variant of the preferred process is employed, the remaining amount of thickener is to be added after wet milling, to give the slurry of the invention.

The slurry of the invention advantageously has a solids content of from 10 to 60% by weight, in particular from 20 to 50% by weight.

The slurry of the invention may be filtered prior to its use. This is done using the customary and known filtration equipment and filters, as also suitable for filtering the known powder clearcoat slurries.

The mesh size of the filters may vary widely and is guided primarily by the particle size and particle-size distribution of the particles of the slurry of the invention. The skilled worker will therefore easily be able to determine the appropriate filters on the basis of this physical parameter. Examples of suitable filters are bag filters. These are available on the market under the brand names Pong® or Cuno®. It is preferred to use bag filters having mesh sizes of from 10 to 50 am, examples being Pong® 10 to Pong® 50.

This illustrates the further particular advantage of the slurry of the invention, namely that it can be filtered without problems even when the minimum film-forming temperature of the particles present therein has been exceeded in the course of wet milling.

To produce the clearcoats of the invention, the slurry of the invention is applied to the substrate that is to be coated. No special measures need be taken here; instead, the application may take place in accordance with the customary and known techniques, which is another particular advantage of the slurry of the invention.

Following its application, the slurry of the invention dries without problems and does not film at the processing temperature, generally at room temperature. In other words, the slurry of the invention applied as a wet film loses water by flashing off at room temperature or slightly elevated temperatures without the particles present therein altering their original solid or highly viscous form. The solid film in powder form loses the residual water by evaporation more easily than a flowing wet film. As a result, the risk of bubbles of evaporated water enclosed in the cured film (popping marks) is reduced. Moreover, the tendency toward mudcracking is extremely low. A surprising finding in this context is that the mudcracking tendency of the slurries of the invention is lower the higher their particle sizes.

In the subsequent baking step, the now substantially water-free powder layer is melted and caused to crosslink. In some cases, it may be of advantage to carry out the leveling process and the crosslinking reaction with a chronological offset, by operating in accordance with a staged heating program or a so-called heating ramp. The appropriate crosslinking temperatures are between 120 and 160° C. The corresponding baking time is between 20 and 60 minutes.

The clearcoat of the invention which results in this case has outstanding performance properties. For instance, the clearcoat of the invention adheres firmly to all customary and known color and/or effect base coats or to substrates such as metal, glass, wood or plastic. It is of high gloss, smooth, scratch-resistant, stable to weathering, and free from defects such as popping marks. Furthermore, on the basis of its advantageous profile of properties, it is suitable even for applications outside of automotive finishing, especially for industrial coating, including coil coating, container coating, and the coating or impregnation of electrical components, and also for the coating of furniture, windows, doors, and interior and exterior architecture. In particular, however, the clearcoat of the invention no longer exhibits any blushing after exposure to moisture. Consequently, the multicoat color and/or effect coating systems of the invention, comprising at least one clearcoat of the invention, are of particularly high utility and particularly long service life.

### EXAMPLES

### Preparation Example 1

The Preparation of a Solution Polyacrylate Resin as Binder

442.84 parts of methyl ethyl ketone (MEK) were introduced into a reaction vessel and heated to 80° C. The initiator, consisting of 47.6 parts of TBPEH (tert-butyl perethylhexanoate) and 33.5 parts of MEK, and the monomer mixture, consisting of 183.26 parts of tert-butyl acrylate, 71.4 parts of n-butyl methacrylate, 95.2 parts of cyclohexyl methacrylate, 121.38 parts of hydroxyethyl methacrylate and 4.76 parts of acrylic acid, were metered into this initial charge at 80° C. over the course of 4 h from two separate feed vessels. The reaction mixture was held at 80° C. for a further 1.5 h. Subsequently, some of the volatile components of the reaction mixture were stripped off under reduced pressure at 500 mbar for 5 h until the solids content was 70% by weight. The resin solution was then cooled to 50° C. and discharged.

The resin solution had the following characteristics:

| | |
|---|---|
| Solids: | 70.2% (1 h at 130° C.) |
| Viscosity: | 4.8 dPas (cone and plate viscometer at |
| | 23° C.; 55% strength solution diluted |
| | with xylene) |
| Acid No.: | 43.4 mg KOH/g solid resin |

### Preparation Example 2

The Preparation of a Blocked Polyisocyanate as Crosslinking Agent (A)

534 parts of Desmodur® N 3300 (commercial trimer of hexamethylene diisocyante from Bayer AG) and 200 parts of MEK were introduced into a reaction vessel and heated to 40° C. Subsequently, with cooling, 100 parts of 3,5-dimethylpyrazole were added, after which an exothermic reaction began. After the exotherm had subsided, a further 100 parts of 3,5-dimethylpyrazole were added, with cooling. After the exotherm had subsided again, a further 66 parts of 3,5-dimethylpyrazole were added. Subsequently, cooling was gradually brought to a stop, whereupon the reaction mixture warmed slowly to 80° C. The reaction mixture was held at this temperature until its isocyanate content had fallen to <0.1%. The reaction product was subsequently cooled and discharged. The blocked polyisocyanate (A) had a solids content of 80% by weight (1 h at 130° C.) and a viscosity of 3.4 dPas (70% in MEK; cone and plate viscometer at 23° C.).

### Preparation Example 3

The Preparation of a Blocked Polyisocyanate as Crosslinking Agent (B)

837 parts of isophorone diisocyanate were introduced into an appropriate reaction vessel, and 0.1 part of dibutyltin dilaurate was added. Then a solution of 168 parts of trimethylolpropane and 431 parts of MEK was run in slowly. The temperature rose as a result of the exothermic reaction. On reaching 80° C., the temperature was held constant by external cooling and the feed stream was restricted slightly if appropriate. After the end of the feed, the mixture was held at this temperature for about 1 hour until the isocyanate content of the solids had reached 15.7% (based on NCO groups). Subsequently, the reaction mixture was cooled to 40° C. and a solution of 362 parts of 3,5-dimethylpyrazole in 155 parts of MEK was added over 30 minutes. After the reaction mixture had warmed up, as a result of the exotherm, to 80° C., the temperature was held constant for 30 minutes until the NCO content had fallen to less than 0.1%. Then 47 parts of n-butanol were added to the reaction mixture, which was held at 80° C. for 30 minutes more and then, after brief cooling, discharged.

The reaction product had a solids content of 69.3% (1 h at 130° C.).

### Example 1

The Preparation of a Powder Clearcoat Slurry of the Invention

321.4 parts of the binder solution as per Preparation Example 1, 57.9 parts of the crosslinking agent solution (B) as per Preparation Example 3, and 120.7 parts of the crosslinking agent solution (A) as per Preparation Example 2 were mixed with stirring at room temperature in an open stirred vessel for 15 minutes. Then 7.2 parts of Cyagard® 1164 (UV absorber from Cytec), 2.2 parts of Tinuvin® liquid 123 (sterically hindered amine “HALS” from Ciba Geigy) 3 parts of N,N-dimethylethanolamine, 1.8 parts of benzoin and 0.6 part of dibutyltin dilaurate were added and the mixture was stirred at room temperature for a further 2 h. The mixture was then diluted with 225.7 parts of deionized water in small portions. After an interval of 15 minutes, a further 260 parts of deionized water were added. An emulsion with a theoretical solids content of 37% was formed.

The emulsion was diluted with 283 parts of deionized water, and on a rotary evaporator the same amount of a mixture of volatile organic solvents and water was stripped off under reduced pressure until the solids content was again 37% by weight (1 h at 130° C.), so giving a slurry.

In order to set the desired viscosity behavior, 22.6 parts of Acrysol® RM-8W (commercial thickener from Rohm & Haas) and 6.5 parts of Viscalex® HV 30 (commercial thickener from Allied Colloids) were added to 1000 parts of the slurry. The resultant powder clearcoat slurry had the following characteristics:

| | |
|---|---|
| Solids content (1 h at 130° C.): | 36.6% |
| Particle size: | 6.4 μm (D.50; laser |
| | diffraction measuring |
| | instrument from Malvern) |
| Viscosity behavior: | 1920 mPas at a shear rate |
| | of 10 s⁻¹ |
| | 760 mPas at a shear rate |
| | of 100 s⁻¹ |
| | 230 mPas at a shear rate |
| | of 1000 s⁻¹ |

Comparative Experiment C1

The Preparation of a Noninventive Powder Clearcoat Slurry

301.6 parts of the binder solution as per Preparation Example 1, and 217.4 parts of the crosslinking agent solution (B) as per Preparation Example 3 were mixed with one another as described in Example 1. Then 7.2 parts of Cyagard® 1146 (UV absorber from Cytec), 2.2 parts of Tinuvin® 123, 2.8 parts of N,N-dimethylethanolamine, 1.8 parts of benzoin and 0.6 part of dibutyltin dilaurate were added. After stirring for 2 hours 207 parts of deionized water were added in small portions and, after an interval of 15 minutes, the resulting mixture was diluted with a further 260 parts of deionized water. An emulsion with a theoretical solids content of 37% by weight resulted.

The emulsion was diluted further with 320.6 parts of deionized water, and on a rotary evaporator the same amount of a mixture of volatile organic solvents and water was stripped off under reduced pressure until the solids content was again 37% by weight (1 h at 130° C.).

In order to set the suitable viscosity behavior, 22.6 parts of Acrysol® RM-8W (commercial thickener from Rohm & Haas) and 6.5 parts of Viscalex® HV 30 (commercial thickener from Allied Colloids) were added to 1000 parts of the slurry.

The resultant powder clearcoat slurry had the following characteristics:

| | |
|---|---|
| Solids content (1 h at 130° C.): | 36.4% |
| Particle size: | 7.2 μm (D.50; laser |
| | diffraction measuring |
| | instrument from Malvern) |
| Viscosity behavior: | 1405 mPas at a shear rate |
| | of 10 s⁻¹ |
| | 690 mPas at a shear rate |
| | of 100 s⁻¹ |

### Example 2 and Comparative Experiment C2

The Production of an Inventive (Example 2) and a Noninventive (Comparative Experiment C2) Clearcoat

In a first experimental series on the application of the powder clearcoat slurries of Example 1 and of the Comparative Experiment C1, an integrated system was prepared, which is described below for the metallic shade “meteor gray”:

Using a gravity feed gun, a functional coat (Ecoprime® Meteorgrau [Meteor gray]; BASF Coatings AG) was applied to steel panels coated cathodically with a commercially customary electrocoat. After flashing off at room temperature for 5 minutes, a Meteor gray aqueous metallic basecoat (Ecostar® Meteorgrau; BASF Coatings AG) was applied in the same way to this coat and subsequently predried at 80° C. for 5 minutes.

After the panels had been cooled, the inventive powder clearcoat slurries of Example 1 and of the Comparative Experiment C1 were applied in the same way. Then, the panels were first flashed off for 5 minutes and then predried at 40° C. for 15 minutes. Subsequently, they were baked at 145° C. for 30 minutes.

This resulted in an inventive (Example 2) and a noninventive (Comparative Experiment C2) aqueous metallic coat system in the shade “Meteor gray”. The applied wet films had been chosen so that, after baking, the dry film thicknesses for the functional coat and the aqueous metallic basecoat were each 15 μm. The inventive (Example 2) and the noninventive (Comparative Experiment C2) clearcoat had a film thickness in each case of from 40 to 45 μm. The table gives an overview of important performance properties of the clearcoats.

The first experimental series was repeated, except that in the second experimental series the powder clearcoat slurries of Example 1 and of the Comparative Experiment C1 were applied in the form of a wedge, giving dry film thicknesses of the clearcoats of from 20 to 100 μm. The table gives information about the limit of the popping stability.

The experimental results reported in the table demonstrate that the clearcoat of Comparative Experiment C2, although having a high popping stability, nevertheless blushes in the hot water test. In contrast, the clearcoat of Example 2 has a higher gloss, a higher brightness, and a comparable popping stability, but does not blush in the hot water test.

TABLE
The performance properties of the inventive (Example 2)
and noninventive (Comparative Experiment C2) clearcoat

| | Comparative | | | |
|---|---|---|---|---|
| | Experiment | | | |
| Properties | C2 | | Example 2 | |
| Dry film thickness | 40-45 | μm | 44-48 | μm |
| Gloss at 20°¹⁾ | 78 | | 85 | |
| Haze¹⁾ | 80 | | 25 | |
| Appearance | glossy | | bright | |
| Leveling | good | | very good | |
| Popping limit | 70 | μm | 65 | μm |

| | | |
|---|---|---|
| Mudcracking | no | no |
| Blushing in the hot water test²⁾ | yes | no |

¹⁾Instrument, manufacturer Byk;
²⁾Following storage of the panels in hot water at 90° C.; for assessment, the edges were protected with a strip of adhesive 1 cm wide; following removal at the end of the test, damage to the unprotected area was easier to perceive.

What is claimed is:

1. A pseudoplastic powder clearcoat slurry free from organic solvents and external emulsifiers and comprising solid and/or highly viscous particles, dimensionally stable under storage and application conditions, having an average size of from 0.8 to 20 μm and a maximum size of 30 μm, said particles comprising at least one binder and at least one crosslinking agent, wherein said crosslinking agent comprises
(A) at least one crosslinking agent which introduces soft segments into the three-dimensional network of the clearcoat, and
(B) at least one crosslinking agent which introduces hard segments into the three-dimensional network of the clearcoat,
or alternatively
(A/B) at least one crosslinking agent which introduces both soft and hard segments into the three-dimensional network of the clearcoat.

2. The slurry as claimed in claim 1, characterized in that the softening segments comprise molecular building blocks which lower the glass transition temperature Tg of three-dimensional networks in which they are included, and the hard segments comprise molecular building blocks which increase the glass transition temperature Tg of three-dimensional networks in which they are included.

3. The slurry as claimed in claim 2, characterized in that the molecular building blocks are divalent organic radicals.

4. The slurry as claimed in claim 3, characterized in that the soft divalent organic radicals are substituted or unsubstituted, linear or branched alkanediyl radicals having 4 to 20 carbon atoms.

5. The slurry as claimed in claim 3, characterized in that the hard divalent organic radicals are substituted or unsubstituted cycloalkanediyl radicals having 4 to 20 carbon atoms.

6. The slurry as claimed in any of claims 1 to 5, characterized in that blocked polyisocyanates are used as crosslinking agent(s) (A), (B) and/or (A/B).

7. The slurry as claimed in claim 6, characterized in that hexamethylenediisocyanate oligomers containing isocyanurate, biuret, allophanate, iminooxadiazinedione, urethane, carbodiimide, urea and/or uretdionel groups are used as blocked polyisocyanates (A).

8. The slurry as claimed in claim 6, characterized in that isophorone diisocyanate oligomers containing isocyanurate, biuret, allophanate, iminooxadiazinedione, urethane, carbodiimide, urea and/or uretdione groups are used as blocked polyisocyanates (B).

9. The slurry as claimed in any of claims 6 to 8, characterized in that blocking agents as
i) phenols such as phenol, cresol, xylenol, nitrophenol, chlorophenol, ethylphenol, t-butylphenol, hydroxybenzoic acid, esters of this acid, or 2,5-di-tert-butyl-4-hydroxytoluene;
ii) lactams, such as ε-caprolactam, δ-valerolactam, γ-butyrolactam of β-propiolactam;
iii) active methylenic compounds, such as diethyl malonate, dimethyl malonate, methyl or ethyl acetoacetate or acetylacetone;
iv) alcohols such as methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, diethylene glycol monomethyl ether, diethylene glycol monoethyl ether, propylene glycol monomethyl ether, methoxymethanol, trimethylolpropane, glycerol, glycolic acid, glycolic esters, lactic acid, lactic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;
v) mercaptans such as butyl mercaptan, hexyl mercaptan, t-butyl mercaptan, t-dodecyl mercaptan, 2-mercaptobenzothiazole, thiophenol, methylthiophenol or ethylthiophenol;
vi) acid amides such as acetoanilide, acetoanisidinamide, acrylamide, methacrylamide, acetamide, stearamide or benzamide;
vii) imides such as succinimide, phthalimide or maleimide;
viii) amines such as diphenylamine, phenyl-naphthylamine, xylidine, N-phenylxylidine, carbazole, aniline, naphthylamine, butylamine, dibutylamine or butylphenylamine;
ix) imidazoles such as imidazole or 2-ethyl-imidazole;
x) ureas such as urea, thiourea, ethyleneurea, ethylenethiourea or 1,3-diphenylurea;
xi) carbamates such as phenyl N-phenylcarbamate or 2-oxazolidone;
xii) imines such as ethyleneimine;
xiii) oximes such as acetone oxime, formaldoxime, acetaldoxime, acetoxime, methyl ethyl ketoxime, diisobutyl ketoxime, diacetyl monoxime, benzophenone oxime or chlorohexanone oximes;
xiv) salts of sulfurous acid such as sodium bisulfite or potassium bisulfite;
xv) hydroxamic esters such as benzyl methacrylohydroxamate (BMH) or allyl methacrylohydroxamate; or
xvi) substituted pyrazoles or triazoles; and
xvii) mixtures of these blocking agents.

10. The slurry as claimed in claim 9, characterized in that 3,4-dimethyl- and/or 3,5-dimethylpyrazole are/is used as substituted pyrazoles (xvi) and 3,4-dimethyl- and/or 3,5-dimethylpyrazole and trimethylolpropane are used as mixture (xvii).

11. The slurry as claimed in any of claims 1 to 10, which has a solids content of from 10 to 60% by weight, in particular from 20 to 50% by weight.

12. The slurry as claimed in any of claims 1 to 11, characterized in that the average size of the solid spherical particles is from 3 to 15 μm.

13. The slurry as claimed in any of claims 1 to 12, comprising ionic thickeners and nonionic associative thickeners.

14. The slurry as claimed in any of claims 1 to 13, characterized in that the solid spherical particles comprise polyols as binders.

15. The slurry as claimed in claim 14, characterized in that they comprise polyacrylates as binders.

16. The slurry as claimed in any of claims 1 to 15, containing from 0.05 to 1 meq/g of ion-forming groups and from 0.05 to 1 meq/g of neutralizing agents and having a viscosity of (i) from 50 to 1000 mPas at a shear rate of 1000 s⁻¹, (ii) from 150 to 8000 mPas at a shear rate of 10 s⁻¹, and (iii) from 180 to 12,000 mPas at a shear rate of 1 s⁻¹.

17. The slurry as claimed in any of claims 1 to 16, which has a minimum film-forming temperature of more than 20° C., in particular more than 30° C.

18. The use of the slurry as claimed in any of claims 1 to 17 to produce clearcoats for automotive finishing and refinishing, the coating of furniture, windows, doors, and interior and exterior architecture, and industrial coating, including coil coating, container coating, and the coating or impregnation of electrical components.

19. A clearcoat and multicoat color and/or effect coating system, producible using the powder clearcoat slurry as claimed in any of claims 1 to 17.
